(19) United States
(12) Patent Application Publication
(10) Pub. No.: US 2005/0223010 A1
(43) Pub. Date: Oct. 6, 2005

(54) Coordination of lifecycle changes of system components

(76) Inventor: Paul Murray, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/091,278

(22) Filed: Mar. 28, 2005

(30) Foreign Application Priority Data
Mar. 30, 2004 (GB) 0407119.7

(51) Int. Cl. G06F 17/30; G06F 7/00; G06F 17/00

(52) U.S. Cl. 707/10; 707/100

(57) ABSTRACT

A method and system are provided for coordinating lifecycle state changes of system components. Each component maintains lifecycle-state information about its current lifecycle state and provides this information to a state-dissemination arrangement. The state-dissemination arrangement disseminates lifecycle state information to interested components such that all components receiving a particular item of lifecycle-state information can, within a defined time, rely on all interested components having received the information. Components use this lifecycle-state information in determining whether to change their lifecycle state.

### FIELD OF THE INVENTION

The present invention relates to a method and system for coordinating lifecycle changes of system components.

### BACKGROUND OF THE INVENTION

A system such as a computer system can be viewed as a collection of cooperating components. Some of these components may depend on others in a way that affects what they can do at any time. For example, in a distributed computer system there will typically be a number of inter-dependent software components such as database and application servers and it may only be possible to start an application server when its database server is running, or it may only be possible stop the database when the application server has stopped using it. When starting or stopping such a software system, it is necessary to start or stop all the components in a coordinated way that respects these dependencies; if this is not done, the system may not operate correctly. More generally, any action taken by one component may need to be coordinated with the action of others. Conceptually, the simplest way to do this is to control all actions from a single point, but this has the disadvantage that the single point needs to know everything about the system and the whole system could stop operating if the single point stops operating.

It is also known to provide a distributed deployment engine; however, this approach requires scripts or structured descriptions to define the order of life cycle operation on the components.

It is an object of the present invention to provide a way of coordinating lifecycle changes in system components that does not require separate coordinating managers but is consistent in operation.

### SUMMARY OF THE INVENTION

According to a first aspect of the present invention, there is provided a system comprising:
resources for providing a plurality of components each arranged to operate according to a respective life cycle comprising a plurality of lifecycle states, each component being further arranged to maintain and provide lifecycle-state information indicative of its current lifecycle state; and
a state-dissemination arrangement for disseminating lifecycle-state information provided by each component to all other components interested in that information, the state-dissemination arrangement being such that all components receiving a particular item of lifecycle-state information can, within a defined time, rely on all interested components having received the information;
   at least one component being arranged to receive lifecycle-state information about another component from the state-dissemination arrangement and to use it in determining whether to change its current lifecycle state.

The system enables the components to coordinate their lifecycles with decisions regarding changing their lifecycle states being taken locally at the components; the state-dissemination arrangement provides for a consistent view to all components of the current component lifecycle states. Absence of lifecycle-state information from a component can be taken as indicating that it does not exist so that the existence of a component can be used by another component in determining whether or not to change its current lifecycle state.

Coordination of life cycle transitions can be both on a sequential basis (one component only effects a particular transition after another component has transited to a specific lifecycle state), and/or on a simultaneous basis (two components effect respective particular transitions at substantially the same time upon a further component transiting to a specific lifecycle state).

The state-dissemination arrangement can be arranged to deliver the state information provided by all the resources to every resource user and manager. Preferably, however, each resource user and the or each resource manager is arranged to register with the state-dissemination arrangement to indicate its interest in particular state information, and the state-dissemination arrangement is arranged to use these registered interests to manage the dissemination of state information.

According to a second aspect of the present invention, there is provided a computer system comprising:
resources for providing a plurality of components each arranged to operate according to a respective life cycle capable of representation as a plurality of lifecycle states between ordered pairings of which the component is arranged to transit upon fulfillment of a corresponding condition set, each component being further arranged to maintain and provide lifecycle state information indicative of its current lifecycle state; and
a state-dissemination arrangement for disseminating the state information provided by the components;
   the condition set associated with at least one state transition of a first said component comprising a condition concerning the existence or current lifecycle state of a second said component, and the first component being arranged to receive state information from the second component via the state-dissemination arrangement and to use it in checking whether said condition has been fulfilled.

According to a third aspect of the present invention, there is provided a method of coordinating the lifecycle of computer system components arranged to operate according to a respective life cycle comprising a plurality of lifecycle states; the method comprising:
maintaining at each of said components lifecycle-state information about its current lifecycle state;
disseminating the lifecycle-state information between components such that all components receiving a particular item of lifecycle-state information can, within a defined time, rely on all interested components having received the information; and
receiving, at a said component, lifecycle-state information at a component about another component and using it in determining whether to change the current lifecycle state of the receiving component.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating the general operation of a state-dissemination service employed in embodiments of the invention;

FIG. 2 is a diagram of a distributed system with multiple processing nodes each including a state-dissemination server;

FIG. 3 is a diagram of a first form of state-dissemination server usable in the FIG. 2 system;

FIG. 4 is a diagram illustrating local register tables maintained by a state manager of the FIG. 3 state-dissemination server;

FIG. 5 is a diagram illustrating global register tables maintained by a state manager of one of the state-dissemination servers of the FIG. 2 system;

FIG. 6 is a diagram illustrating enhancements to the form of state-dissemination server shown in FIG. 3;

FIG. 7 is a state transition diagram showing two lifecycle states of a component;

FIG. 8 is a diagram showing a system, similar to that of FIG. 2, in which the lifecycle state of one component is used to govern a lifecycle state transition of another component; and

FIG. 9 is a lifecycle state transition diagram of a component intended to operate in conjunction with a replicate with one component normally being in standby and the other active.

### BEST MODE OF CARRYING OUT THE INVENTION

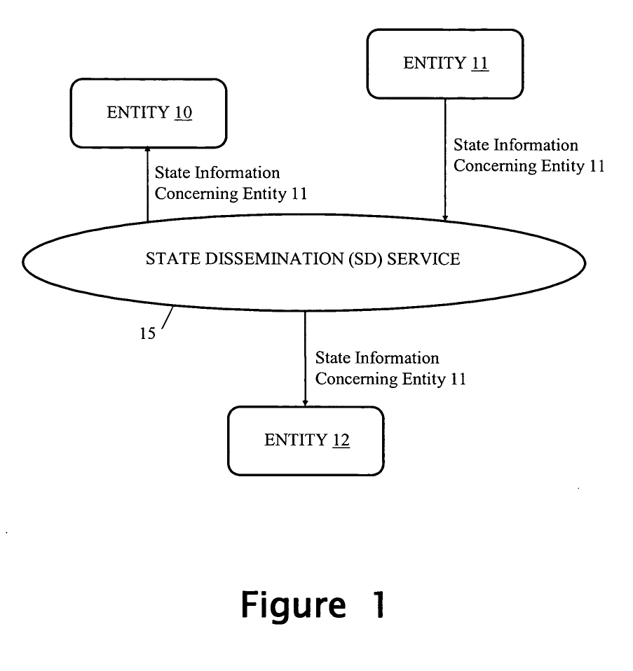

The embodiments of the invention to be described hereinafter are based on the dissemination of state information about an entity of a system from that entity to other entities of the system. FIG. 1 depicts the general operation of such a state-dissemination service. More particularly, FIG. 1 shows three entities 10, 11, and 12 each of which has access to a state-dissemination service 15. The entity 11 has state information that it is willing to share with other entities 10, 12; accordingly, the entity 11 provides its state information to the state-dissemination service 15, this typically being done each time the information changes in any way. The state-dissemination service 15 is then responsible for providing the state information concerning entity 11 to the entities 10 and 12.

The state-dissemination service 15 can be arranged simply to supply the state information it receives from any entity to every other entity; however, preferably, each entity that wishes to receive state information registers a state-information indicator with the state-dissemination service 15 to indicate the particular state information in which it is interested in receiving. This indicator could, for example, simply indicate that the registering entity wants to receive all state information provided by one or more specified other entities; alternatively, the indicator could indicate the identity of the particular state information that the registering entity wants to receive regardless of the entity providing it. In this latter case, when state information is provided by an entity to the state-dissemination service 15, the providing entity supplies a state-information identifier which the service 15 seeks to match with the indicators previously registered with it; the provided state information is then passed by the state-dissemination service to the entities which have registered indicators that match the identifier of the provided state information.

Rather than this matching being effected by the state-dissemination service 15 at the time the state information is provided to it, entities that intend to provide state information to the service 15 are preferably arranged to register in advance with the service to specify state-information identifier(s) for the state information the registering entity intends to provide; the state-dissemination service 15 then seeks to match the registered identifiers with the registered indicators and stores association data that reflects any matches found. The association data can directly indicate, for each registered identifier, the entities (if any) that have registered to receive that information; alternatively, the association data can be less specific and simply indicate a more general pattern of dissemination required for the state information concerned (for example, where the entities are distributed between processing nodes, the association data can simply indicate the nodes to which the state information should be passed, it then being up to each node to internally distribute the information to the entities wishing to receive it). The association data is updated both when a new identifier is registered and when a new indicator is registered (in this latter case, a match is sought between the new indicator and the registered identifiers).

When an entity subsequently provides state information identified by a state-information identifier to the state-dissemination service, the latter uses the association data to facilitate the dissemination of the state information to the entities that have previously requested it by registering corresponding state-information indicators.

As will be more fully described below, where the entities are distributed between processing nodes, the state-dissemination service is preferably provided by an arrangement comprising a respective state-dissemination server entity at each node. In addition, where the state-dissemination service operates by generating association data from supplied state-information identifiers and indicators, preferably not only are the state-information identifiers and indicators associated with the entities at each node recorded in registration data held by that node, but the association data concerning the state-information identifiers registered by the node entities of that node is also stored at the node. Furthermore, each node preferably stores source data indicating, for each state-information indicator registered by the entities of that node, the origin of the corresponding state information. As will be explained hereinafter, by arranging for this local storage of registration data, association data and source data, a relatively robust and scalable state-dissemination service can be provided.

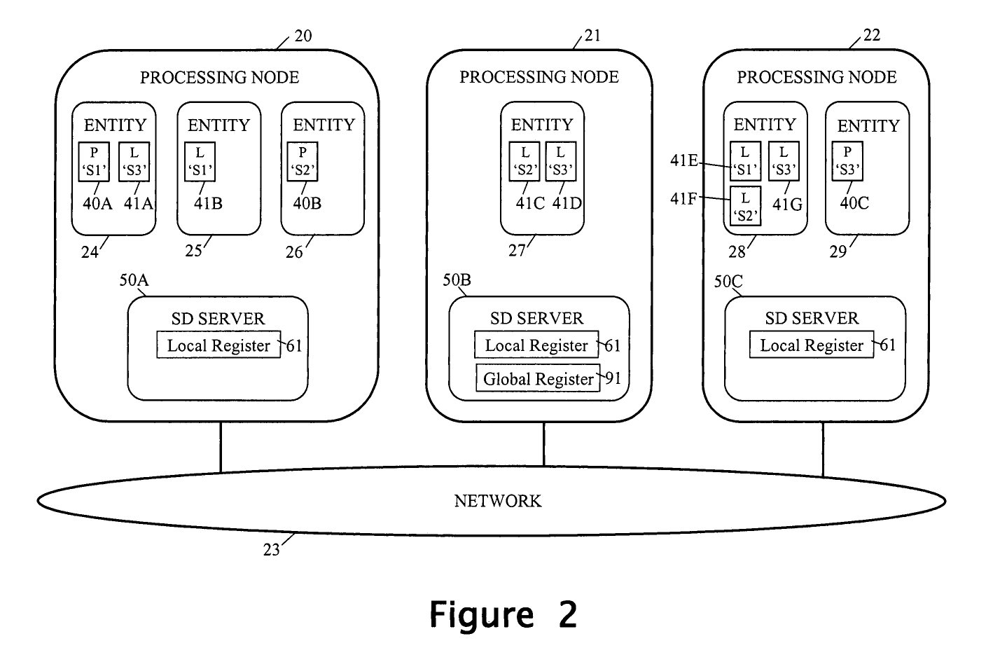

FIG. 2 shows an example distributed system with multiple processing nodes 20, 21 and 22 arranged to intercommunicate via any suitable communication arrangement here shown as a network 23. Node 20 includes entities 24,25 and 26, whilst node 21 includes entity 27 and node 22 includes entities 28 and 29.

The FIG. 2 system operates a state-dissemination service provided by a state-dissemination arrangement comprising a respective state-dissemination (SD) server 50A, 50B and 50C at each node 20, 21 and 22; the SD servers are arranged to communicate with each other via the network 23.

Each one of the entities 24 to 29 that intends to provide state information to the state-dissemination service is arranged to register a corresponding state-information identifier with the local SD server 50 (that is, with the SD server at the same node). To this end, each such entity instantiates a software “state provider” object P (generically referenced 40) and passes it the identifier of the state information to be provided to the state-dissemination service. The state provider object 40 is operative to the register itself and the state-information identifier with the local SD server 50 and the latter stores this registration data in a local register 61; the state provider object 40 is also operative to subsequently provide instances of the identified state information to the SD server.

Similarly, each one of the entities 24 to 29 that wishes to receive particular state information from the state-dissemination service is arranged to register a corresponding state-information indicator with the local SD server 50 (that is, with the SD server at the same node). To this end, each such entity instantiates a software “state listener” object L (generically referenced 41) and passes it the indicator of the state information to be provided by the state-dissemination service. The state listener object 41 is operative to register itself and the state-information indicator with the local SD server 50 and the latter stores this registration data in the local register 61; the state listener object 41 is also operative to subsequently receive the indicated state information from the SD server.

It will be appreciated that the use of software state provider and listener objects 40 and 41 to interface the entities 24 to 29 with their respective SD servers 50 is simply one possible way of doing this.

In the present example, regarding the provision of state information:
Entity 24 of node 20 is arranged to provide state information identified by state-information identifier ‘S1’ to which end the entity instantiates state provider 40A which registers itself and the identifier S1 with SD server 50A;
Entity 26 of node 20 is arranged to provide state information identified by state-information identifier ‘S2’ to which end the entity instantiates state provider 40B which registers itself and the identifier S2 with SD server 50B; and
Entity 29 of node 22 is arranged to provide state information identified by state-information identifier ‘S3’ to which end the entity instantiates state provider 40C which registers itself and the identifier S3 with SD server 50C;

Regarding the receipt of state information:
Entity 24 of node 20 is interested in receiving state information indicated by state-information indicator ‘S3’ to which end the entity instantiates state listener 41A which registers itself and the indicator S3 with SD server 50A;
Entity 25 of node 20 is interested in receiving state information indicated by state-information indicator ‘S1’ to which end the entity instantiates state listener 41B which registers itself and the indicator S1 with SD server 50A;
Entity 27 of node 21 is interested in receiving state information indicated by either one of state-information indicators ‘S2’ and ‘S3’, to which end the entity instantiates corresponding state listeners 41C and D each of which registers itself and the indicator S2 and S3 respectively with SD server 50B; and
Entity 28 of node 22 is interested in receiving state information indicated by any one of state-information indicators ‘S1’, ‘S2’ and ‘S3’, to which end the entity instantiates corresponding state listeners 41E, F, and G each of which registers itself and the indicator S1, S2 and S3 respectively with SD server 50C.

The data registered by the or each state provider and/or listener associated with a particular node constitutes registration data and is held by the SD server of that node.

In this example, it can be seen that the same state-information labels S1, S2, and S3 have been used for the state-information identifiers and indicators; in this case, the matching of identifiers and indicators carried out by the state-dissemination service simply involves looking for a full match between an identifier and indicator. However, using exactly the same identifiers and indicators is not essential and matching based on parts only of an identifier and/or indicator is alternatively possible (for example, the state-dissemination service can be arranged to determine that a state-information indicator ‘abcd’ is a match for a state-information identifier ‘abcdef’). Furthermore, although not illustrated in the FIG. 2 example, an entity can be arranged to provide the same state information under several different identifiers; in the present case, this involves instantiating a respective state provider for each identifier. In addition, as well as more than one state listener registering the same state-information indicator as illustrated in FIG. 2, more than one state provider can register the same state-information identifier.

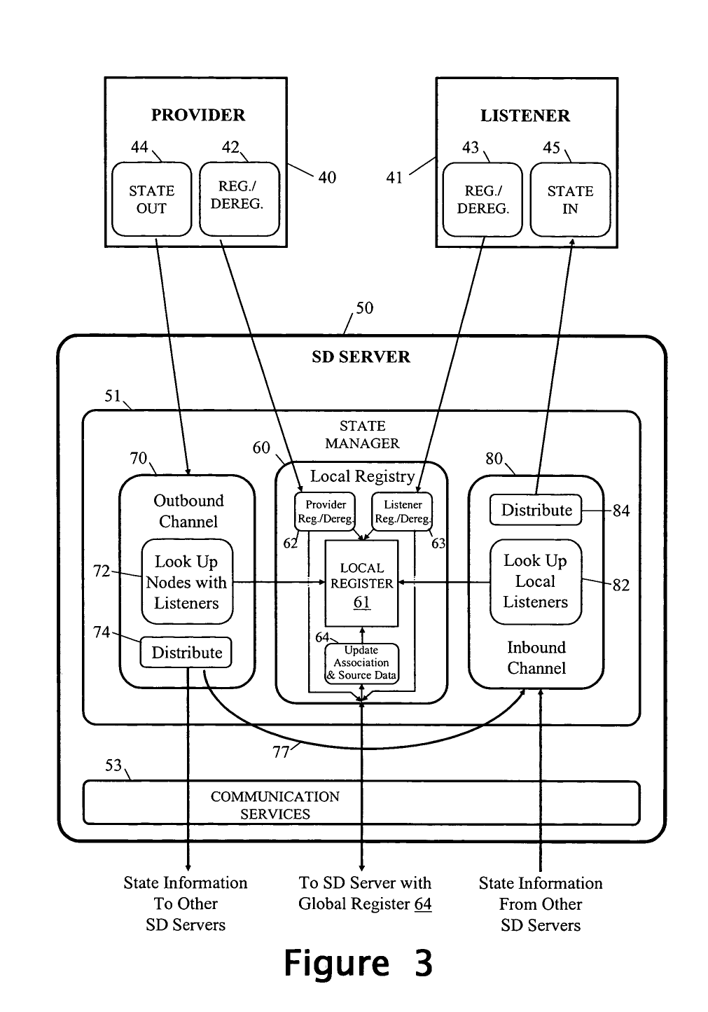

The state-dissemination service provided by the SD servers 50A-C is arranged to derive association data and source data from the registered state-information identifiers and indicators. In the present case, the association data is used to indicate, for each state-information identifier, the SD server(s) where corresponding indicators have been registered; the source data is used to indicate, for each state-information indicator, the SD server(s) where corresponding identifiers have been registered (of course, the source data can also be considered to be a form of association data, however, the term ‘source data’ is used herein to distinguish this data from the above-mentioned data already labelled with the term ‘association data’). For each identifier, the corresponding association data is held by the SD server where the identifier is registered; similarly, for each indicator, the corresponding source data is held by the SD server where the indicator is registered. As will be more fully explained below with reference to FIGS. 3 to 5, the association data and source data are determined in the present example by making use of a global register; 91, maintained by one of the SD servers, that records the SD server(s) where each identifier and indicator has been registered. The global register 91 is only used for compiling the association data and source data and its loss is not critical to the dissemination of state information in respect of previously registered state-information identifiers and indicators already taken account of in the association data held by operative SD servers; furthermore, the contents of the global register can be reconstituted from the registration data held by the operative SD servers.

FIG. 3 shows in more detail one implementation of the SD servers 50 of the FIG. 2 system. The SD server 50 shown in FIG. 3 comprises a state manager functional block 51 and a communications services functional block 53, the latter providing communication services (such as UDP and TCP) to the former to enable the state manager 51 to communicate with peer state managers of other SD servers.

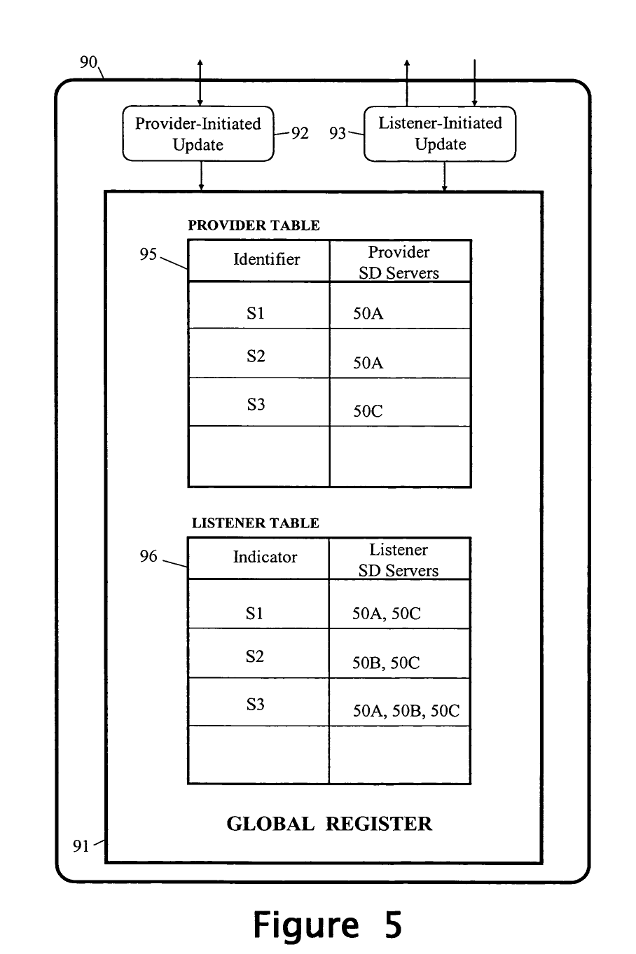

The state manager 51 comprises a local registry 60, an outbound channel for receiving state information from a local state provider 40 and passing this information on to other SD servers 50 as required, and an inbound channel 80 for distributing state information received from other SD servers 50 to interested local listeners 41. The state manager of one of the SD servers also includes a global registry; all SD servers have the capability of instantiating the global register and the servers agree amongst themselves by any appropriate mechanism which server is to provide the global registry. The registry is not shown in the state manager 51 of FIG. 3 but is separately illustrated in FIG. 5

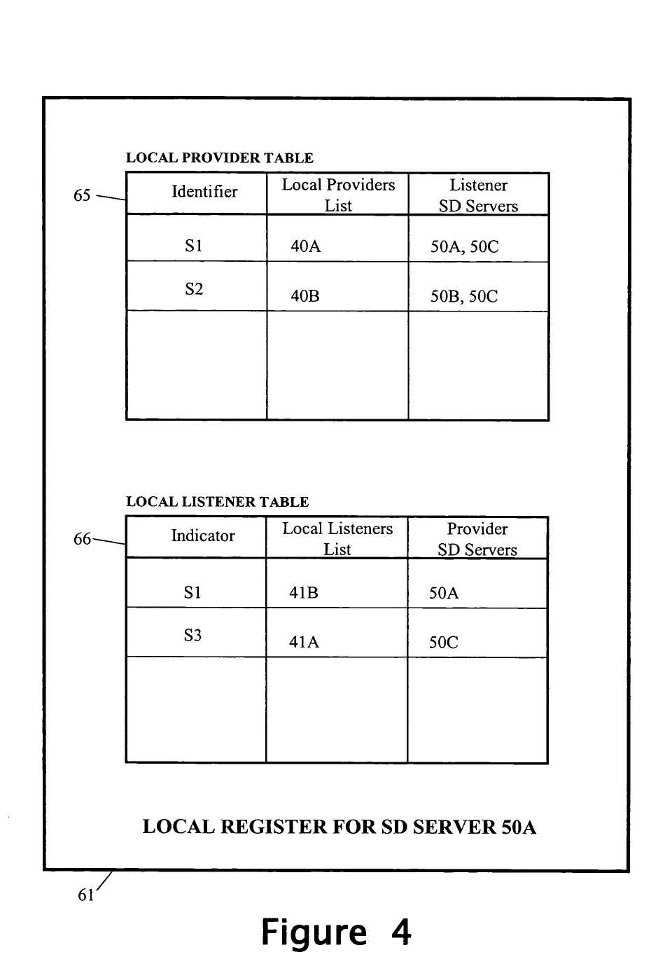

The local registry 60 comprises the local register 61 for holding the registration data concerning the local entities as represented by the local providers 40 and listeners 41, the association data for the state-information identifiers registered by the local providers 40, and source data for the state-information indicators registered by the local listeners 41. As depicted in FIG. 4, the local register 61 is actually organised as two tables, namely a local provider table 95 and a local listener table 66.

In the local provider table 65, for each identifier registered by a local provider 40, there is both a list of the or each local provider registering that identifier, and a list of every SD server, if any, where a matching state-information indicator has been registered. Table 65 thus holds the registration data for the local providers 40 and their associated identifiers, along with the association data concerning those identifiers.

In the local listener table 66, for each indicator registered by a local listener 41, there is both a list of the or each local listener registering that indicator, and a list of every SD server, if any, where a matching state-information identifier has been registered. Table 66 thus holds the registration data for the local listeners 41 and their associated indicators, along with the source data concerning those indicators.

With respect to the global registry 90 (FIG. 5), this comprises a global register 91 holding both a provider table 95 and a listener table 96. The provider table 95 lists the state-information identifiers that have been notified to it and, for each identifier, the or each SD server where the identifier is registered. The listener table 96 lists state-information indicators that been have notified to it and, for each indicator, the or each SD server where the indicator is registered.

When a local provider 40 is first instantiated, a registration/deregistration functional element 42 of the provider 40 notifies the local registry 60 and the registration process proceeds as follows:
(a) A functional element 62 of the registry 60 checks if the state-information identifier associated with the new provider is present in provider table 65—if not, a new entry is added. The functional element 62 then adds the identity of the new provider to the entry for the associated identifier in the provider table 65.
(b) If a new entry had to be created in table 65 for the identifier associated with the new provider, then the following operations are effected:
   (i) The functional element 62 sends an identifier registration message including the registration details to the global registry 90 by using the communication services provided by block 53.
   (ii) A functional element 92 of the global registry 90 effects the following operations upon receipt of the identifier registration message at the global registry:
      A check is first made as to whether the identifier concerned is already present in the provider table 95 and, if so, the identity of the SD server from which the identifier registration message was sent is added to the list of servers associated with the existing entry for the identifier; if there is no existing entry for the identifier in table 95, a new entry is created and the identity of the SD server from which the just-received message was sent is made the first entry in the list of servers associated with the new entry.
      Matches are sought between the identifier in the identifier registration message and the state-information indicators in the listener table 96. A list of the SD servers associated with any matches found (the ‘listener SD servers’) is then returned in an association-data update message to the local registry 60 which sent the identifier registration message.
   (iii) The SD-server list returned in the association-data update message to the local registry 60 of the SD server that originated the identifier registration message, is received by a functional element 64 which then updates the association data held in the local provider table 65 of register 61 in respect of the identifier concerned, by adding the listener SD servers in the association-data update message to the list of listener SD servers for that identifier.

In a similar manner, when a local listener 41 is first instantiated, a registration/deregistration functional element 43 of the listener 41 notifies the local registry 60 and the registration process proceeds as follows:
(a) A functional element 63 of the registry 60 checks if the state-information indicator associated with the new listener is present in listener table 66—if not, a new entry is added. The functional element 63 then adds the identity of the new listener to the entry for the associated indicator in the listener table 66.
(b) If a new entry had to be created in table 65 for the identifier associated with the new provider, then the following operations are effected:
   (i) The functional element 63 sends an indicator registration message including the registration details to the global registry 90 by using the communication services provided by block 53.
   (ii) A functional element 93 of the global registry effects the following operations upon receipt of the identifier registration message at the global registry:
      A check is first made as to whether the indicator concerned is already present in the listener table 96 and, if so, the identity of the SD server from which the indicator registration message was sent is added to the list of servers associated with the existing entry for the indicator; if there is no existing entry for the indicator in table 96, a new entry is created and the identity of the SD server from which the just-received message was sent is made the first entry in the list of servers associated with the new entry.
      Matches are sought between the indicator in the indicator registration message and the state-information identifiers in the provider table 95. Each of the SD servers associated with any matches found (the ‘provider SD servers’) is then sent an association-data update message including the identity of the SD server that originated the registration message and the relevant identifier(s) found to match the newly registered indicator.
   (iii) At each SD server that receives an association-data update message, the functional element 64 updates the association-data held in the local provider table 65 of register 61 by adding the SD server included in the association-data update message to the list of listener SD servers for the or each identifier referenced in the message.

With regard to the updating of the source data held in the local listener table 66 of each SD server 66 in response to the registration of a new provider 40 or listener 41, this is effected by the inbound channel 80 of each SD server when it receives state information in respect of an identifier that the registry 60 finds is a match for one or more state-information indicators in the table 66 (the handling of newly-received state information by the state manager 60 is described more fully below)

Rather than a newly registered listener having to wait for a change in state information for which it has registered before receiving that state information, provision can be made for providers of this information to send the current version of the state information of interest to the listener concerned (either by a dedicated exchange of messages or by the provider(s) being triggered to re-send their information via the state-dissemination arrangement).

The deregistration of a provider 40 or listener 41 is effectively the reverse of registration and involves the same functional elements as for registration. The main difference to note is that an identifier/indicator deregistration message is only sent from the local registry 60 to the global registry 90 if a state-information identifier or indicator is removed from the local provider table 65 or local listener table 66 (which is done when there ceases to be any associated provider or listener respectively).

In normal operation, upon an entity detecting a change in state information for which it has a provider 40 registered with its local register 60, a functional element 44 of the provider notifies the outbound channel 70 of the local register that there is new state information in respect of the state-information identifier concerned. A functional element 72 of the outbound channel 70 then looks up in the local provider table 65 of the register 60, the association data for the identifier in order to ascertain the SD servers to which the new state information needs to be sent; the new state information is then distributed, together with its identifier, to these servers by functional element 74. This distribution will typically involve use of the communication services provided by block 53; however, where a local listener 41 (that is, one at the same node) has registered to receive the state information, then the functional element 74 simply passes it to the inbound channel 80 of the same server (see arrow 77 in FIG. 3).

When an SD server 50 receives new state information, identified by a state-information identifier, from another SD server, it passes the information to the inbound channel 80 of the state manager 51. Upon new state information being received at the inbound channel 80 (whether from another SD server or from the local outbound channel), a functional element 82 of the inbound channel uses the identifier associated with the new state information to look up in the local listeners table 66 the listeners that have registered state-information indicators that match the identifier. The functional element 82 also checks that the SD server that sent the state information is in the list of provider SD servers for each matched indicator, if this is not the case, the list is updated (thereby updating the source data for the indicator concerned). A functional element 84 of the inbound channel is then used to distribute the received state information to the matched listeners 41 where it is received by respective functional elements 45 of the listeners.

As so far described, the state-dissemination arrangement of the FIG. 2 system provides a basic state-dissemination service (in fact, for this basic service, the source data and the functional elements that handle and use it are not required). This basic state-dissemination service only permits certain limited assumptions to be made by entities using the service; thus, an entity that has registered to receive particular state information can only assume that any version of this information that it observes has existed at some stage, but cannot assume that other entities registered to receive the information have also observed the same information.

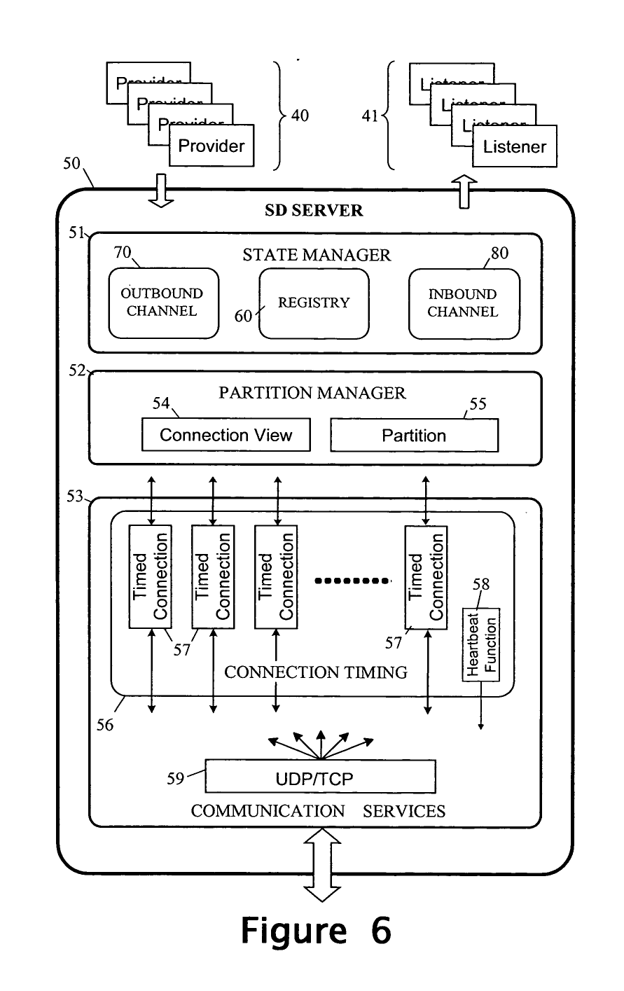

As will be described below with reference to FIG. 6, the basic state-dissemination arrangement is preferably enhanced to provide better consistency properties for the state information it disseminates. More particularly, two enhanced forms of state-dissemination arrangement are described:
in the first enhanced form (herein referred to as the “TSD” arrangement) connection-timing functionality 56 is added to the communications services functional block 53 of each SD server 50 to provide the overall arrangement with the properties of a fail-aware timed asynchronous system, and
in the second enhanced form (herein referred to as the “TPSD” arrangement) in addition to the connection-timing functionality, a partition manager 52 is inserted between the state manager 51 and the communications services block 53 of each SD server to divide the state-dissemination arrangement into partitions. A partition is a collection of entities in a system that can all pass state information to one another within a given time limit. If two entities cannot pass state information between one another within the time limit they cannot be in the same partition. All entities exist in exactly one partition.

It may be noted that, for present purposes, any internal time delays in a node in passing state information received by an SD server to a listener or in notifying it that the information is no longer available, can be discounted. The communication timings between SD servers are therefore taken as being representative of the communication timings between entities (more specifically, between providers and matched listeners).

Considering first the TSD arrangement, the connection-timing functionality 56 added to the communications services block 53 comprises a respective timed-connection functional element 57 for checking the timing of communication between every other SD server and the subject SD server. This check involves checking that communication is possible between every other SD server and the subject server within a predetermined time value (for example, 3 seconds). To this end, every SD server is provided with a heartbeat message function 58 which broadcasts periodic messages, identifying the originating SD server, to every other server; this broadcast is, for example effected using the UDP service provided by the block 53. When an SD server receives such a heartbeat messages it passes it to the timed-connection functional element 57 associated with the server that originated the heartbeat message. This functional element 57 thereupon resets a timer that was timing out a period equal to the aforesaid predetermined time interval. Provided this timer is reset before time out, the connection with the corresponding server is considered to be timely. The interval between heartbeat messages is such that several such messages should be received by an associated timed-connection functional element 57 over a period equal to the predetermined time value so that it is possible for a heartbeat message to be missed without the corresponding timer timing out.

In the event that the timer of a timed-connection functional element 57 times out, the state manager 51 of the same SD server is notified that timely communication with the server associated with that functional element 57 has been lost. The state manager 51 then uses the source data held in the local register 61 to determine which of the local listeners 41 were registered to receive state information from the SD server with which timely communication has been lost; these listeners are then informed that state information is no longer available from this server.

The heartbeat messages broadcast by a SD server 50 also enables a new SD server to announce itself to the existing SD servers, the connection timing function 56 of each existing SD server being arranged to listen out for broadcast heartbeat messages from new SD servers and to instantiate a new timed-connection functional element 57 for each such server detected.

It will be appreciated that the above described way of checking communication timing is simply one example of how to carry out this task and many other ways are possible, for example, by the use of round trip timing or by time-stamping one-way messages using synchronized clocks at all SD servers.

The operational messages passed between the SD services (such as those used to distribute state information) are, in the present example, sent on a point to point basis using the TCP service provided by block 53. These messages are preferably also used for checking communication timing, temporarily substituting for the heartbeat messages.

The enhanced state-dissemination service provided by the TSD arrangement ensures that listeners only receives timely information. Furthermore, a state listener can assume that all other state listeners with an equivalent matching indicator will either see the same state information from a given provider within the aforesaid predetermined time limit or are notified that there is no such state information within the same time limit.

Considering next the TPSD arrangement, the partition manager 52 that is interposed between the communication services block 53 and the state manager 51 in each SD server, implements a partition membership protocol and a leader election protocol. Suitable implements of such protocols will be apparent to person skilled in the art so only a brief description is given here.

The partition manager 52 uses three conceptual views of the SD servers that are participating in the state-dissemination service, each view being determined locally. The first, the connection set, is the set of connections between the subject SD server and other SD servers identified by the communication services block 53. The second view, the connection view 54, is derived directly from the connection set and represents SD servers that are potential members of a partition including the subject SD server. All SD servers in the connection set are admissible to the connection view 54, except those that are untimely or have recently been untimely. All partition managers 52 communicate their connection views 54 to each other whenever these views change, so each SD server has a copy of the connection view derived by every node in its own connection view—the fact that these connections are timely guarantees that the exchanges of connection views are timely.

The collection of connection views 54 known to the partition manager 52, including its own view, are used to derive the partition including the subject SD server. A partition manager 54 is said to be stable when its collection of connection views remain unchanged and they all agree (i.e. they are all the same). When stable, the partition manager 54 sets the partition 55 to be the same as the local connection view. When unstable, the partition manager 54 reduces the partition by selectively evicting SD servers according to the changes. Each partition manager 54 derives its own partition, but the sharing of connection views and the function used to derive the partition provide the following properties:
1. If a partition manager is stable and its partition is P, then all partitions derived elsewhere are either subsets of P or do not intersect P.
2. If two partition managers are stable and their partitions are P and Q, then either P equals Q or P does not intersect Q.
3. If a partition manager is continuously stable between times t and t+Δ and its partition is P, then each node in P is stable at time t and has the same partition (here Δ is the aforesaid predetermined time limit).

The second property is actually derived from the first, if two partitions are subsets of each other then clearly they are the same, and so these two actually represent one property. The second property is stated to emphasise the point that the partition managers either converge on the same partition or distinctly different partitions—they do not overlap. As a result, by the time one partition manager stabilizes, all SD servers that are excluded from its partition know that they are excluded; or rather they derive their own partition that does not intersect it. The third property demonstrates that if the partition remains stable then all SD servers will figure this out.

The leader election protocol operates similarly to the partition protocol. As well as exchanging connection views 54 the partition managers 52 exchange leader candidates. Each manager re-evaluates its choice of leader when connection view changes occur in such a way that they all chose the same leader. Conveniently, the leader SD server provides the global registry 90.

By arranging for each SD server 50 only to send registration messages to the global registry 90 of the same partition 55, the state listeners 41 only see state information from state providers 40 that are in the same partition as them.

The enhanced state-dissemination service provided by the TPSD arrangement enables a state listener to assume that all other state listeners with equivalent matching indicators are either in the same partition and see all the same state information within the given predetermined time limit or they are not in the same partition and do not see any of the same state information within the same time limit.

Listeners are informed by the SD servers when the partition has become unstable. If a provider provides state information s at time t to the TPSD service, then provided the partition remains stable, all interested listeners will receive the information s by time t+Δ. All such listeners can each then know by time t+2Δ that all other interested listeners have received the information s because it will be aware by this time of any disruption of the partition that would have prevented another interested listener from receiving the information by the time t+Δ.

Put another way, whenever an entity is informed by its local SD server that the partition of which it is a member is no longer stable, such an entity knows that it cannot rely upon the receipt by interested entities of the partition, of any item of lifecycle-state information which the entity itself has received within an immediately preceding time period of duration corresponding to 2Δ.

It may be noted that the TPSD service has the effect of partitioning the totality of state information knowledge. When the partitions are stable, two entities either have access to the same knowledge partition or non-overlapping knowledge partitions. So, whatever state information the entities are interested in knowing, even if these are completely different items of state information, will be consistent. Thus, if a first entity knows state information s by time t+Δ, then at time t+2Δ this entity knows that whatever state information a second entity knew by time t+Δ, is consistent with information s, whether it be the information s or something else all together.

The state-dissemination arrangements described above, including all the variants mentioned, are suited for use in disseminating life-cycle state information between entities formed by components of a system and, in particular, between software components of a distributed computer system (by ‘software component’ is meant a component that can be instantiated and terminated as required and takes the form of one or more processes that work together to provide a particular function). As will be described below, this enables the lifecycle changes of such components to be coordinated.

The life cycle of a component can be expressed as a state machine, with a number of states and transitions between states. Typical states include “STARTING” during which a component is initializing, “STANDBY” during which a component is ready but not active, and “ACTIVE” when a component is actively performing its intended function. The life cycles of the components of a system are often inter-dependent. For example, one component may depend on a second component already being in a particular state before it can transition to its next state. These dependencies are frequently found in system instantiation or termination as in the following examples from a system comprising application server components and a database component:
it may be inappropriate to transition an application server component to its running state until the database server component has transitioned to a running state.
it may be inappropriate to transition a database server component to its terminated state until all application server components using, it have transitioned to a quiescent state.

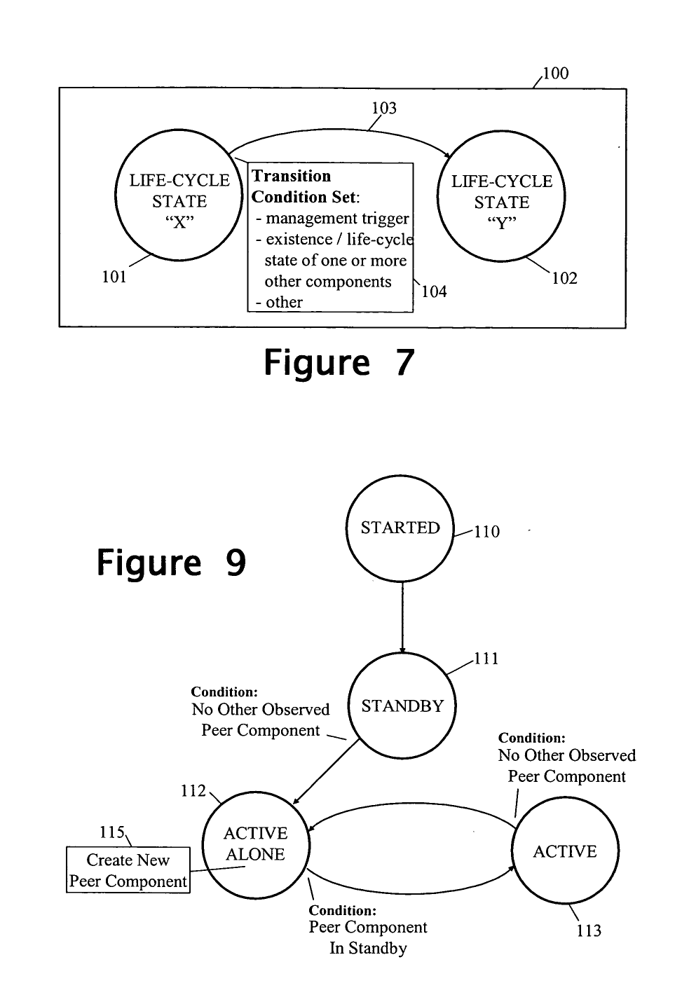

By way of illustration, FIG. 7 depicts two lifecycle states “X” and “Y” of a component 100, these states being referenced 101 and 102 respectively; arrow 103 represents a possible transition between states “X” and “Y”. It is to be noted that whilst the transition from “X” to “Y” is possible, the transition from “Y” to “X” may not be; thus, typically transitions will only exist between a subset of all possible ordered pairings of lifecycle states.

Associated with each possible transition is an explicit or implicit set of one or more conditions that must be fulfilled before the transition can be executed. Condition set 104 in FIG. 7 is an example of explicit conditions to be tested by the component concerned. An example of an implicit condition is that certain actions associated with the current state (such as component initialization) have been completed—usually this condition does not need to be explicitly tested as the possibility of exiting the state concerned is not considered until after the actions associated with the state have been completed.

The explicit condition set 104 shown in FIG. 7 comprises three conditions:
a management trigger condition;
a condition concerning the existence or current lifecycle state of each of one or more other components;
some other condition.

All three conditions must be satisfied before the condition set 104 is fulfilled and the transition 102 can be taken. The condition set 104 is given simply by way of example and it is to be understood that condition sets associated with other state transitions can contain more or less conditions as required.

With respect to the management trigger condition, this condition, if present, requires that a particular management input has been received at a management interface of the component concerned. The required management input is, for example, a specific direction or authorisation to transit to the lifecycle state “Y” (that is, the lifecycle state reached by the transition governed by the condition set 104 comprising the management trigger condition). A further example of a required management input is a direction or authorisation to transit lifecycle states until a specific state is reached where this specific state is other than the current lifecycle state “X” of the component concerned.

With regard to the condition concerning the existence or current lifecycle state of each of at least one other component of the system, this type of condition enables the lifecycles of the system components to be coordinated. To this end, each component is arranged to maintain a state variable indicative of its current lifecycle state and to provide this lifecycle state information to the state-dissemination arrangement for delivery to other components that may be interested (generally because the current lifecycle state of the providing component forms part of a lifecycle state transition condition set, such as condition set 104). In the present case, the component 100 is arranged to receive from the state-dissemination arrangement the lifecycle state information it needs for checking the corresponding condition. With regard to determining the existence or otherwise of another component, absence of lifecycle-state information from a component is taken as indicating that the component concerned does not exist.

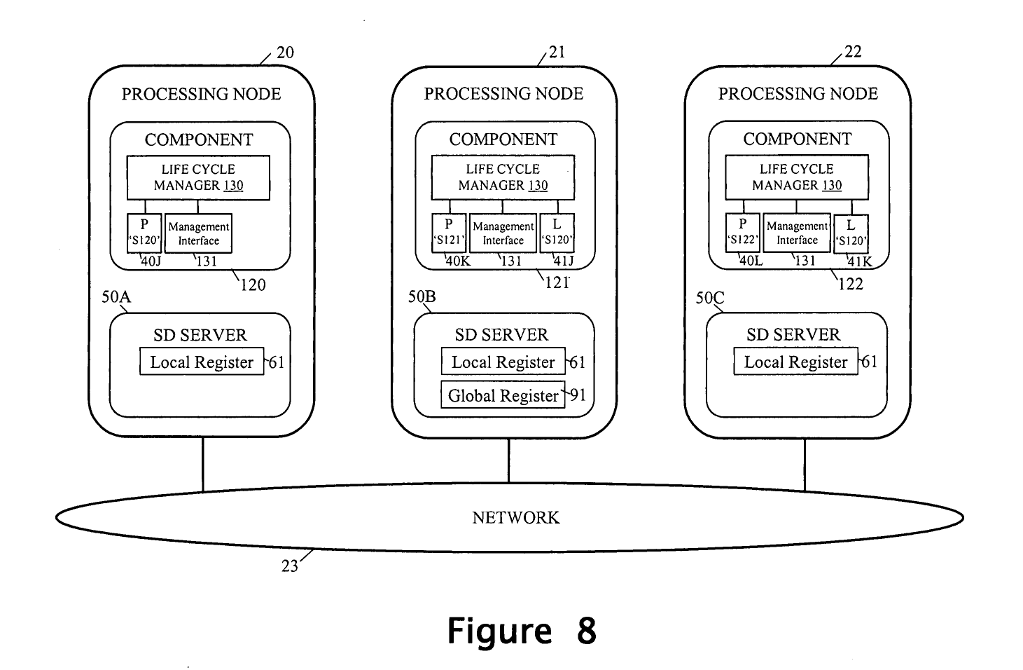

FIG. 8 shows a system similar to that of FIG. 2 in that it comprises three processing nodes 20, 21 and 22, a network 23, and a state-dissemination arrangement comprising SD servers 50A, 50B, 50C (preferably a TPSD arrangement but possibly a TSD arrangement or a basic state-dissemination arrangement). Components 120, 121 and 122 are present at processing nodes 20, 21 and 22 respectively. Each component operates according to a life cycle that can be represented as a set of lifecycle states between predetermined ordered pairings of which the component is arranged to transition upon fulfillment of corresponding condition set. To this end, each component 120, 121 and 122 has a life cycle manager function 130 that effectively implements a state machine representing the lifecycle of the component; in particular, the life cycle manager 130 maintains a state variable representing the current state of the component and is arranged to check for fulfillment of the condition set(s) governing the transition of the component from its current state. Each life cycle manager 130 has an associated management interface 131 for receiving management input (as already discussed, the presence of such input can constitute a transition condition).

Each life cycle manager 130 is arranged to instantiate a state provider 40 for providing the current lifecycle state of the component of which it forms a part to the local SD server.

Thus:
component 120 has a provider 40J for providing the lifecycle state of this component, identified by identifier S120, to SD server 50A;
component 121 has a provider 40K for providing the lifecycle state, identified by identifier S121, to SD server 50B;
component 122 has a provider 40L for providing the lifecycle state of this component, identified by identifier S122, to SD server 50C.

Each provider 40J, 40K and 40L is arranged to provide its associated lifecycle state information upon a change in the current lifecycle state of the component concerned.

Each life cycle manager 130 is further arranged to instantiate a listener 41 for each other component from which it wishes to receive current lifecycle state information as a result of the current lifecycle state (or the existence or non-existence) of that component being in a transition condition set governing the lifecycle transitions of the component of which the life cycle manager forms a part. In the present example, both the components 121 and 122 wish to know the current lifecycle state of the component 120 and their lifecycle managers have accordingly instantiated listeners 41J and 41K respectively, both listeners being in respect of state-information indicator S120.

In the simplest case where the presence of component 120 in a particular state “Z1” is used by both components 121 and 122 as the sole condition for transiting from respective states Z2 and Z3, then when the component 120 is not initially in its state “Z1” and the components 121 and 120 are in their respective states “Z2” and “Z3”, the life cycle managers 130 of the components 120 and 121 will both be waiting to receive lifecycle state information from component 120, via the state-dissemination arrangement, indicative of that component entering its state “Z1”. As soon as this happens, the components 121 and 122 are informed and transit out of their respective states “Z1” and “Z2”. This simple example illustrates that coordination of life cycle transitions can be both on a sequential basis (component 121/122 only effects its transition after the component 120 has transited to a specific lifecycle state), and/or on a simultaneous basis (two components 121, 122 effect respective transitions at substantially the same time upon the component 120 transiting to a specific lifecycle state). However, as will be more fully discussed below, a component can only rely on coordination on a simultaneous basis where the state-dissemination arrangement is the TPSD arrangement because only in this case can the component be sure that the lifecycle-state information it observes is also observed by all other all interested components within a predetermined time limit.

The components observe the following consistency properties depending on the type of dissemination service used:
If a basic SD service is used, a component receiving lifecycle-state information can only assume that the lifecycle state values it observes represent states that the associated components occupy or have occupied. This level of consistency is suitable to ensure that a transition in one component precedes a transition in another component. For example, an application server component could wait for a database server to start before it starts, but it cannot be sure how long it will take to be informed that the database has started; in fact it may never receive the notification.
If a TSD service is used, a component receiving lifecycle-state information can assume that any lifecycle state value it observes is correct to within a given time limit. This gives the component a consistency guarantee for each state value it observes and a consistency guarantee among all the state values it observes. This level of consistency allows the component to correlate the values of multiple state variables according to when they are received by it and so coordinate life cycle transitions with satisfaction of distributed predicates (e.g. “start application server C when application servers A and B are both in overload”). Using only a basic SD service, it is always possible that a component has transitioned to a lifecycle state that has not yet been reported, and so it would not be possible to determine that such a condition would be recognized.
If a TPSD service is used, a component receiving lifecycle-state information can assume:
   that the value it observes for a lifecycle state variable will be correct to within a given time limit;
   that all other components in the same partition observing the same state variable will observe the same lifecycle state value within the same given time limit (though the receiving component can only rely on this after twice the time limit);
   that all other components in other partitions cannot observe the same lifecycle state variable; and
   that a component that has recently left the partition will no longer observe the same lifecycle state variable within the given time limit.
This gives a consistency guarantee among all lifecycle state values observed by all components. This level of consistency allows multiple components to coordinate life cycle transitions based on mutual observations. In particular, it is possible for a component to correctly evaluate a transition condition that requires the simultaneous existence of two observed lifecycle states.

A particularly useful application of lifecycle coordination concerns fully distributed startup coordination to instantiate an entire system. In this case, a running state dissemination service needs to be present which the components can use to announce their own lifecycle state values and observe the lifecycle state values of others. All components understand their own life cycle and their transition constraints are encoded as predicates associated with the life cycle transitions. All the components can be deployed immediately without any coordination and instructed, via their management interfaces, to perform the transitions that take them to their running state; each component will determine when to perform its own transitions as the appropriate transition condition sets are satisfied. As an alternative to the components being instructed to transit to their running states, the components can simply be arranged to effect whatever transitions become valid as a result of the corresponding condition sets being satisfied (the condition sets not including any required management input).

Components can make other types of state information, additional to current lifecycle state information, available either by providing it in association with the lifecycle state information or by instantiating additional state providers for that information. As an example, an application server component may provide information about its current workload. This information can then be used in the transition condition sets of other components.

FIG. 9 illustrates an example lifecycle state diagram of a component that is intended to automatically effect valid lifecycle state transitions to take it to an active state in coordination with other components, the coordination being guaranteed by the use of TPSD arrangement for disseminating lifecycle state information. The example concerns an active-standby component replication scheme for high availability that uses the following component life cycle:
When a component is created it is initially in the STARTED state 110.
When the component is in the STARTED state 110 and has completed initialization, it transits to a STANDBY state 111.
When the component is in the STANDBY state 111, it transits to an ACTIVE_ALONE state 112 upon fulfillment of a condition set that no other peer component (a replicate of itself) exists or continues to exist (disappears).
When the component is in the ACTIVE_ALONE state 112, it initiates creation of a new peer component and carries out its intended operational role; upon fulfillment of a condition set that a peer component is in STANDBY, the component transits to an ACTIVE state 113.
When the component is in the ACTIVE state 113 it continues to carry out its intended operational role and upon fulfillment of a condition set that no peer component continues to exist, returns to the ACTIVE_ALONE state 112.

This example assumes that there are no partition changes throughout. Starting one such component would lead to it progressing through STARTED, STANDBY, and ACTIVE_ALONE, finally reaching ACTIVE after starting a second, replicate, component. The second component will reach the STANDBY state. Therefore the normal running configuration has one ACTIVE component and one STANDBY component.

If the component in the ACTIVE state fails the other component would transit to ACTIVE_ALONE, create a new standby, and then transit to ACTIVE. If the component in STANDBY fails the other will return to ACTIVE_ALONE to create a new standby component, and then transit back to ACTIVE.

The components provide their system function so long as one of them is in the ACTIVE or ACTIVE_ALONE state and so only a simultaneous failure of both components takes the function out of service.

In the FIG. 9 example, each component is arranged to provide its current lifecycle state to the TPSD service under a type-specific identifier common to all replicates rather than under a component-specific identifier; similarly, each component registers to receive lifecycle information from replicates as identified by a type-specific indicator matching the type-specific identifier.

The embodiments described above with reference to FIGS. 7 to 9 provide a fully distributed approach to coordinating component life cycles. There is no central control that needs to gather or maintain information about component states purely to coordinate transitions, or that can fail and render the system temporarily or permanently inoperable. Furthermore, the component life cycle dependencies are declarative and there is no need to derive an explicit sequence of component transitions that satisfy the dependency constraints. As indicated, the system can be created by randomly creating all the components and letting them organize themselves. As a result the mechanism that creates the system can do its job without being involved in the coordination of startup.

It will be appreciated that many variants are possible to the above described embodiments of the invention. For example, the implementations of the state-dissemination arrangement described with reference to FIGS. 2 to 6 are by way of example and other implementations are possible, particularly with respect to how the interest of an entity in particular state information is associated with the source(s) of such information.

Whilst components are preferably arranged to provide their lifecycle state information to the state-dissemination service whenever this lifecycle state information changes, the lifecycle state information can additionally or alternatively be provided to the state-dissemination service in other circumstances, such as at regular time intervals.

It will be appreciated that the SD servers and components described above will typically be implemented using appropriately programmed general purpose program-controlled processors and related hardware devices (such as storage devices and communication devices). However, other implementations are possible.

The state-dissemination arrangements described herein can be used for disseminating other types of state information in addition, or alternatively, to lifecycle state information.

1. A system comprising:
resources for providing a plurality of components each arranged to operate according to a respective life cycle comprising a plurality of lifecycle states, each component being further arranged to maintain and provide lifecycle-state information indicative of its current lifecycle state; and
a state-dissemination arrangement for disseminating lifecycle-state information provided by each component to all other components interested in that information, the state-dissemination arrangement being such that all components receiving a particular item of lifecycle-state information can, within a defined time, rely on all interested components having received the information;
at least one component being arranged to receive lifecycle-state information about another component from the state-dissemination arrangement and to use it in determining whether to change its current lifecycle state.

2. A system according to claim 1, wherein each component has for each of a plurality of ordered pairings of its lifecycle states, a corresponding condition set governing the transition of the component between the lifecycle states concerned; at least one component having at least one condition set comprising a respective condition concerning the existence or current lifecycle state of each of at least one other said component, the or each component with such an associated condition being arranged to use lifecycle-state information received from the state-dissemination arrangement to enable it to check for fulfillment of that condition.

3. A system according to claim 2, wherein at least two said components are arranged to have a same said condition governing corresponding respective transitions, this condition concerning another component being in a particular current lifecycle state whereby achievement of that state by said another component is arranged to cause coordinated transitions by said at least two components.

4. A system according to claim 2, wherein a said component which has a condition set comprising a said condition, includes a management interface for receiving management input, the condition set that comprises said condition further comprising a management trigger condition requiring for its fulfilment the receipt at the management interface of a predetermined management input.

5. A system according to claim 4, wherein said predetermined management input is a specific direction or authorisation to transit to the lifecycle state reached by the transition governed by the condition set comprising said management trigger condition.

6. A system according to claim 4, wherein said predetermined management input is a direction or authorisation to transit lifecycle states until a specific state is reached where said specific state is other than the current lifecycle state of the component concerned.

7. A system according to claim 2, wherein the component resources are arranged to provide replicate components of a specific type each with a set of lifecycle states comprising:
an active state in which the component is arranged to carry out a particular function,
an active-alone state in which the component is arranged both to carry out said particular function and to cause the provision of a further replicate component of said specific type, and
a standby state arranged to be reached by a newly provided replicate component before said active or active-alone states;
each replicate component of said specific type having at least the following associated condition sets:
a first condition set governing transition from the standby state to the active-alone state and comprising a condition that there are no other existing replicate components of said specific type,
a second condition set governing transition from the active-alone state to the active state and comprising a condition that there is an existing replicate component of said specific type that is in its standby state,
a third condition set governing transition from the active state to the active-alone state and comprising a condition that there are no other existing replicate components of said specific type.

8. A system according to claim 1, wherein each component is arranged when first provided to ascertain from its associated transition condition sets from which other components it needs to receive lifecycle state information in order to check for fulfilment of the condition sets, and then to register its interest in receiving lifecycle state information in respect of those components with the state-dissemination arrangement.

9. A system according to claim 1, wherein the state-dissemination arrangement is arranged to deliver the lifecycle-state information provided by each component to the or each other component.

10. A system according to claim 1, wherein in order to receive lifecycle-state information about any particular component, each component is arranged to register with the state-dissemination arrangement to indicate its interest in that lifecycle-state information; the state-dissemination arrangement being arranged to use these registered interests to manage the dissemination of lifecycle-state information.

11. A system according to claim 10, wherein each component is arranged to register its interest in lifecycle-state information about any particular component by registering a state-information indicator indicative of that lifecycle-state information, and each component is arranged to provide lifecycle-state information identified by a state-information identifier; the state-dissemination arrangement including association means for matching state-information identifiers with registered state-information indicators whereby to enable the dissemination of lifecycle-state information to be managed by the state-dissemination arrangement according to the registered interests of the components.

12. A system according to claim 11, wherein each component is arranged to register with the state-dissemination arrangement a state-information identifier for lifecycle-state information to be provided by the component, the association means of the state dissemination arrangement being arranged to match registered state-information identifiers with registered state-information indicators and to store association data associating each registered state-information identifier with data for managing the dissemination of the lifecycle-state information identified by that identifier, the state dissemination arrangement being arranged to use the association data in disseminating said state information.

13. A system according to claim 12, wherein the state-dissemination arrangement comprises multiple state-dissemination servers arranged to communicate with each other; each component being operatively associated with a respective said state-dissemination server, and said association data serving to associate each registered state-information identifier with the or each state-dissemination server operatively associated with any component that has registered a state-information indicator matching the identifier; each state-dissemination server being arranged to use the association data to disseminate the lifecycle-state information it receives from a component, to the or each server indicated by the association data as being associated with the identifier with the latter server being arranged to pass on the lifecycle-state information to the or each component operatively associated with it that has registered a state-information indicator matching the identifier of the lifecycle-state information concerned.

14. A system according to claim 13, comprising processing nodes interconnected by a communications network; the components being distributed between the processing nodes as part of the latter, and each processing node being provided with a respective said state-dissemination server with the servers being arranged to communicate with each other over the communications network.

15. A system according to claim 13, wherein each state-dissemination server is arranged to store registration data indicative, for the or each component with which it is operatively associated, of any state-information identifiers and indicators registered by the component concerned.

16. A system according to claim 13, wherein the association means comprises a respective portion forming part of each said state-dissemination server, each such portion being arranged to store said association data in respect of the state-information identifiers registered by any components operatively associated with the server of which the portion forms a part.

17. A system according to claim 13, wherein each said state-dissemination server is arranged to store source data indicative, for the state-information indicators registered by any component operatively associated with the server, of the or each state-dissemination server that is operatively associated with a said component registered to provide lifecycle-state information corresponding to said indicators.

18. A system according to claim 13, wherein the association means comprises a respective state manager forming part of each said state-dissemination server, the state manager of each state-dissemination server comprising a local registry which in turn comprises:
a local register arranged to store the association data related to the server, and registration data indicative, for the or each component associated with the server, of any state-information identifiers and indicators registered by the component concerned;
first update means arranged to register a state-information identifier for a said component operatively associated with the server, by updating the registration data in the local register accordingly; and
second update means arranged to register a state-information indicator for a said component operatively associated with the server, by updating the registration data accordingly.

19. A system according to claim 18, wherein the association means further comprises a global registry; the first update means of each local registry being arranged when registering a new state-information identifier to send a first message including that identifier to the global registry, and the second update means of each local registry being arranged when registering a new state-information indicator to send a second message including that indicator to the global registry; the global registry comprising:
a global register arranged to store, for each said state-information identifier and indicator, data indicative of the or each state-dissemination server where that identifier or indicator has been registered;
first update means responsive to receipt of a said first message to update the global register regarding the identifier in the message, find any matching state-information indicator in the global register, and return to the server that sent the message association-update data indicative of the or each state-dissemination server where a matching indicator was registered; and
second update means responsive to receipt of a said second message to update the global register regarding the indicator in the message, find any matching state-information identifier in the global register, and send to the or each state-dissemination server where that identifier was registered, association-update data indicative of the state-dissemination server that sent the second message;
each local registry further comprising third update means for updating the said association data held by the local register in response to receipt of said association-update data from the global registry.

20. A system according to claim 11, wherein each said component is arranged to register a state-information identifier comprising at least a generic portion the same for all components, the association means being such as to detect a match between all these identifiers and a state-information indicator comprising this generic portion whereby a component can register a single state-information indicator to receive state information from all components.

21. A system according to claim 11, wherein the association means is arranged to detect a match between a said state-information identifier and a state-information indicator only in the event of a complete match over the full extent of both.

22. A system according to claim 11, wherein the association means is arranged to detect a match between a said state-information identifier and a state-information indicator upon at least a part of the identifier matching at least a part of the identifier

23. A system according to claim 11, wherein at least one component is arranged to register a further state-information identifier identifying additional state information not including the current lifecycle state of the component, and at least one other said component is arranged to register a further state-information indicator matching said further state-information identifier whereby to receive said additional state information.

24. A system according to claim 1, wherein the state-dissemination arrangement includes communication timing means for monitoring the communication time taken to disseminate lifecycle-state information from a providing component to the or each component that wishes to receive lifecycle-state information from it, the communication timing means being arranged to cause the or each component wishing to receive the lifecycle-state information to be informed, upon the monitored communication time for disseminating information to them from the providing component concerned exceeding a predetermined time value corresponding to half said defined time, that lifecycle-state information for the providing component is no longer available.

25. A system according to claim 24, wherein the state-dissemination arrangement further includes partition means for identifying non-overlapping collections where each collection comprises components between all of which state information can be disseminated within said predetermined time limit as monitored by the communication timing means; the state-dissemination arrangement being arranged to provide the components of a said collection only with lifecycle-state information from components within the same collection; and the state-dissemination arrangement being further arranged to inform the components of a collection of any disruption to collection membership whereby each such component knows that it cannot rely upon the receipt by interested components of the collection, of any item of lifecycle-state information which the component itself has received within an immediately preceding time period of duration corresponding to said defined time.

26. A system according to claim 17, wherein each state-dissemination server includes communication timing means arranged to monitor whether the server can still communicate within a communication time limit corresponding to half said defined time with other state-dissemination servers and, upon this limit not being met in respect of any such other server, to use the source data of the server of which it forms a part to inform any operatively-associated component that had registered to receive lifecycle-state information coming from a said component associated with the server with which communication is out of time, that this lifecycle-state information is no longer available.

27. A system according to claim 26, wherein each state-dissemination server further includes partition means for identifying, in cooperation with the partition means of other servers, a collection of servers, including itself, between all of which lifecycle-state information can be disseminated within said predetermined time limit as monitored by the communication timing means of the servers, the partition means being such that each state-dissemination server only belongs to one collection; the state-dissemination arrangement being arranged to provide the components of a said collection with lifecycle-state information only from components within the same collection; and each state-dissemination server of a collection being further arranged to inform its operatively associated components of any disruption to collection membership whereby each such component knows that it cannot rely upon the receipt by interested components of the collection, of any item of lifecycle-state information which the component itself has received within an immediately preceding time period of duration corresponding to said defined time.

28. A computer system comprising:
resources for providing a plurality of components each arranged to operate according to a respective life cycle capable of representation as a plurality of lifecycle states between ordered pairings of which the component is arranged to transit upon fulfillment of a corresponding condition set, each component being further arranged to maintain and provide lifecycle state information indicative of its current lifecycle state; and
a state-dissemination arrangement for disseminating the state information provided by the components;
the condition set associated with at least one state transition of a first said component comprising a condition concerning the existence or current lifecycle state of a second said component, and the first component being arranged to receive state information from the second component via the state-dissemination arrangement and to use it in checking whether said condition has been fulfilled.

29. A method of coordinating the lifecycle of computer system components arranged to operate according to a respective life cycle comprising a plurality of lifecycle states; the method comprising:
maintaining at each of said components lifecycle-state information about its current lifecycle state;
disseminating the lifecycle-state information between components such that all components receiving a particular item of lifecycle-state information can, within a defined time, rely on all interested components having received the information; and
receiving, at a said component, lifecycle-state information about another component and using it in determining whether to change the current lifecycle state of the receiving component.

30. A method according to claim 29, wherein each component has for each of a plurality of ordered pairings of its lifecycle states, a corresponding condition set governing the transition of the component between the lifecycle states concerned; at least one component having at least one condition set comprising a respective condition concerning the existence or current lifecycle state of each of at least one other said component, the or each component with such an associated condition using the disseminated lifecycle-state information to enable it to check for fulfilment of that condition.

31. A deployment method, incorporating the method of claim 30, for deploying a system that comprises a plurality of software components each arranged to operate according to a respective life cycle comprising a plurality of lifecycle states, the deployment method comprising starting the components independently and using the method of claim 30 to coordinate the transition of the components through their lifecycle states to achieve the states they are intended to occupy during system operation.
